(19) United States
(12) Patent Application Publication
(10) Pub. No.: US 2023/0284852 A1
(43) Pub. Date: Sep. 14, 2023

(54) HAZARDOUS DUST COLLECTION SYSTEM

(71) Applicant: Nicholas Johnstone, Cornubia (AU)

(72) Inventor: Nicholas Johnstone, Cornubia (AU)

(73) Assignee: TRACS QLD Ply Lid T/A BREATHESAFE, Archerfield (AU)

(21) Appl. No.: 18/104,596

(22) Filed: Feb. 1, 2023

Related U.S. Application Data
(60) Provisional application No. 63/305,654, filed on Feb. 1, 2022.

(51) Int. Cl. A47L 9/16; A47L 9/10; A47L 9/12

(52) U.S. Cl. CPC A47L 9/1683; A47L 9/104; A47L 9/12; A47L 9/165

(57) ABSTRACT

A system for safely capturing dust is disclosed. The system includes a dust containment system including a filter member within the containment unit. The dust containment unit is selectively attachable to a vacuum base whereby the dust containment unit with filter member therein can be selectively disconnected from the vacuum base, sealed, and disposed of, and a new dust containment unit can then be attached to the vacuum base.

### PRIORITY

The present application claims the benefit of domestic priority based on U.S. Provisional Patent Application 63/305,654 filed on Feb. 1, 2022, the entirety of which is incorporated herein by reference.

### BACKGROUND

Global recognition and awareness of the hazardous and long term impact from the inhalation of dust particulate is a growing health concern.

Often in the past dust has been classified as either hazardous material or non-hazardous material. However, we now understand that dust particulates of any material can be hazardous and can severely impact long term health. It is the level of exposure that is the real issue and that determines the potential impact on short or long term health. Examples of exposure can be as simple as residential vacuuming in enclosed environments with poorly designed equipment, to Clean down work crews on industrial sites. While cleaning personnel can be at a particularly high level of exposure, the same is also true of indirect personnel, such as a bystander in a house, or a machine operator on a work site or a machine operator or maintenance operator on a work site.

One area of particular concern for dust particle exposure is in the field of mobile plant and fixed plant equipment for industrial applications, such as mining and drilling equipment. There is an ever-increasing global demand for ore, oil, gas, and other resources. This need must be constantly balanced against the potential dangers associated with the processes, some of which are only being fully realized in recent times, and some still being evaluated for harmful impact. The work process of the plant equipment generates dust, or the equipment operate in an environment in which dust particles are present. The potentially hazardous effects of this dust have been well documented. Mobile plant and fixed plant equipment operates in mine sites, drilling sites, landfill sites, construction sites, chemical processing sites, shipping ports, farming operations, and the like. Individuals exposed to the work process created dust have been known to experience silicosis, asbestosis, coal worker's pneumoconiosis, and/or other ailments. Operators in and near the dust, such as individuals in the operator cabin of mining and drilling machinery, or the maintenance and service crew personnel, need to avoid as much dust exposure as possible to maximize their health and safety.

The dust is not only potentially hazardous to humans but can also be damaging to equipment. Due to both the size and the abrasive qualities of work process dust, it can have an impact on sensitive machine equipment, in particular electrical and moving components. It can also have an impact on autonomous control system components including electrical terminals and wiring. These issues can be compounded in work sites where the dust particles are created from materials which are corrosive or can become electrically charged. An operator cabin in a piece of plant equipment can include control devices within the cabin that can be damaged by dust and reduce their reliability and/or increase their need for maintenance procedures. In addition, cabinets, such as an electrical cabinet, can be present on mining and drilling machinery. These cabinets can often house important equipment that needs to be protected from dust. For example, these cabinets can house electrical controls and devices and autonomous drive systems on self-driving machines.

This has led to companies removing dust from operator cabins, electrical cabinets, and the equipment in general on a pre-planned continuous basis. Machine operators can vacuum their machine cabin pre and/or post shift to remove dust particulate from their environment and protect both themselves and surrounding control systems. Maintenance personnel can vacuum machine control cabinets pre and post maintenance procedures. To commence and facilitate maintenance troubleshooting and repairs, dust is usually removed. To increase and ensure reliability (MTBF etc.,) after these procedures, dust particulate and specifically metal particulate (from drilling, cutting or filing, misplaced fasteners etc.) are often removed.

There is therefore a need for an improved system for safely capturing and removing dust. There is a further need for an improved system for safely removing dust from a cabin, such as an operator's cabin, system cabinets, and other parts of a machine. There is a further need for an improved manner of safely emptying or cleaning the equipment used for this process. For example, a vacuum cleaner filter which has been used to remove hazardous dust in turn needs to be safely removed and cleaned or replaced once it has been filled or a job/work process has been completed. Exposure during this process can be particularly high due to the concentrated quantities of hazardous dust/particulate and therefore exists a need for a safe method of control during this procedure.

### SUMMARY

The present invention satisfies these needs. In one aspect of the invention, an improved system for safely capturing and removing dust is provided.

In another aspect of the invention, a system for safely capturing dust includes a dust containment system including a filter member within the containment unit.

In another aspect of the invention, a system for safely capturing dust includes a dust containment system including a filter member within the containment unit, wherein the dust containment system and filter member are disposable as a unit.

In another aspect of the invention, a system for safely capturing dust includes a dust containment system including a filter member within the containment unit, wherein the dust containment unit is sealable.

In another aspect of the invention, a system for safely capturing dust includes a dust containment system including a filter member within the containment unit, wherein the dust containment unit is selectively attachable to a vacuum base whereby the dust containment unit with filter member therein can be selectively disconnected from the vacuum base and disposed of.

In another aspect of the invention, a system for safely capturing dust includes a dust containment system including a filter member within the containment unit, wherein the dust containment unit is selectively attachable to a vacuum base whereby the dust containment unit with filter member therein can be selectively disconnected from the vacuum base, sealed, and disposed of.

In another aspect of the invention, a system for safely capturing dust includes a dust containment system including a filter member within the containment unit, wherein the dust containment unit is selectively attachable to a vacuum base whereby the dust containment unit with filter member therein can be selectively disconnected from the vacuum base, sealed, and disposed of, and a new dust containment unit can then be attached to the vacuum base.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic perspective top view of a dust collection system of the invention;

FIG. 1B is a schematic perspective bottom view of the dust collection system of FIG. 1A;

FIG. 1C is a schematic front view of a version of the dust collection system of FIG. 1A;

FIG. 2 is a schematic perspective side view of a version of the dust collection system of FIG. 1A;

FIG. 3A is a schematic side view of the dust collection system of FIG. 1A showing a dust containment unit being separated from a vacuum body;

FIG. 3B is a schematic side view of the dust collection system of FIG. 1A showing a dust containment unit being connected to a vacuum body;

FIG. 4A is a schematic side view of the dust containment unit of the dust collection system of FIG. 1A;

FIG. 4B is a schematic sectional view of the dust containment unit of FIG. 4A in the forward direction of A-A;

FIG. 4C is a schematic sectional view of the dust containment unit of FIG. 4A in the rearward direction of B-B;

FIG. 5A is a schematic front view of the dust containment unit of the dust collection system of FIG. 1A;

FIG. 5B is a schematic sectional view of the dust containment unit of FIG. 5A in the direction of of the red arrows;

FIG. 6A is a schematic rear view of the interior of a dust containment unit of the invention;

FIG. 6B is a schematic perspective view from the rear of the interior of the dust containment unit of FIG. 6A.

FIG. 7 is a schematic side view of a version of a dust collection system of the invention;

FIG. 8A is a schematic sectional side view of an operator cabin having dust containment system installed;

FIG. 8B is a schematic sectional side view of another version of an operator cabin having a dust collection system installed; and

FIG. 8C is a schematic perspective view of a portable version of a dust collection system of the invention.

### DESCRIPTION

The present invention relates to a system for collecting dust, such as hazardous dust. More particularly, the present invention relates to collecting, removing, containing, and/or disposing of such dust. Although the invention is illustrated as being useful as a system for collecting hazardous dust from within a cabin, such as mining and drilling operator and/or equipment cabins, the present invention can be useful in other instances. Accordingly, the present invention is not intended to be limited to the examples and embodiments described herein.

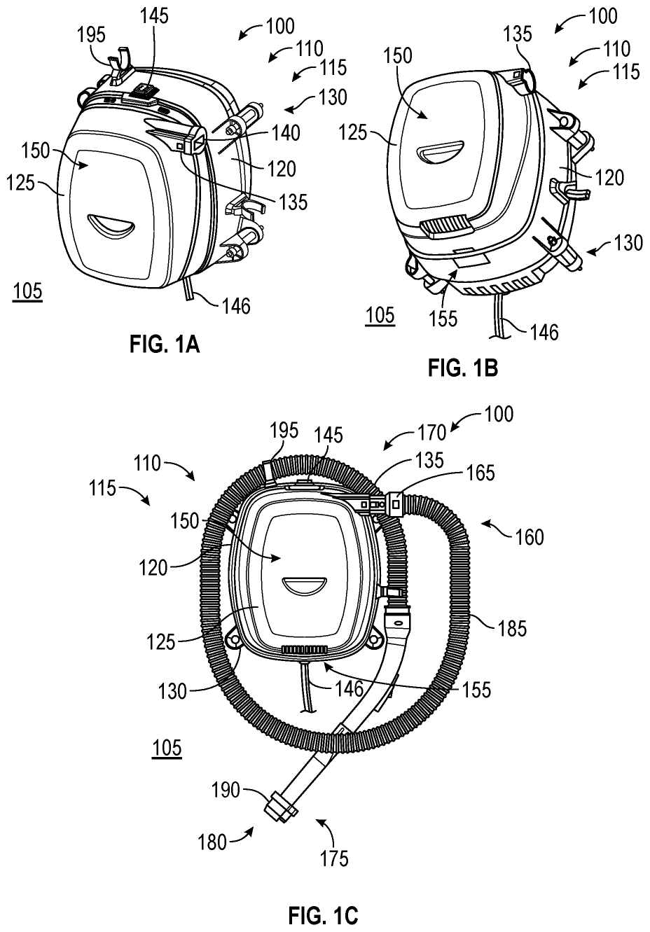

FIG. 1A shows a dust collection system 100 according to the invention. The dust collection system 100 can be useful for removing, containing, storing, allowing for the disposal of, or otherwise controlling the level or presence of dust in an environment 105. The dust collection system 100 includes a dust collection body 110 positionable in or near the environment 105 that has dust that is to be removed or controlled. The dust collecting body 110 has a housing 115 made up of a vacuum base 120 and a dust containment unit 125. The vacuum base 120 houses control mechanisms, motor, and fan and is used to generate a vacuum. The dust containment unit 125 serves as a dust collection and containment vessel into which dust particles from the environment 105 may be drawn and captured. The vacuum base 120 may include a wall attachment mechanism 130 by which the dust collection body 110 can be mounted to a wall or other structure within or near the environment 105. An inlet 135 is provided that provides access to the interior of the dust containment unit 125. A plug 140 is releasably engageable with the inlet 135 to seal the inlet 125 so that dust does not pass into or out of the dust containment unit 125 when the plug 140 is inserted into the inlet 135.

To operate the dust collection system 100, the plug 140 is removed from the inlet 135 and the vacuum base 120 is turned on my flipping power switch 145. The power switch initiates activation of the vacuum base 120 which may be powered by power cord 146 or other power source. When powered, the vacuum base generates a suction that is delivered to the dust collection body 125 which in turn applies a suction to the inlet 135 to cause dust particles to be drawn into the dust containment unit 125 through the open inlet 135. The dust containment unit 125 includes a filtering mechanism 150 that prevents dust particles from passing into the vacuum base 120 and thus helps to collect and retain the dust particles within the dust containment unit 125. This also prevents and/or reduces dust from reaching the electric motor and/or other components extending the life of this components. The dust containment unit 125 is releasably connected to the vacuum body 120 by a releasable connection mechanism 155. Upon completion of a dust removal procedure, the plug 140 can be reinserted into the inlet 135 so that the collected dust will be retained within the dust containment unit 125. The dust containment unit 125 can then be separated from the vacuum body 120 by releasing the releasable connection mechanism 155. The dust containment unit 125 and the dust contained therein can then be safely disposed of and a new dust containment unit 125 can be connected to the vacuum body 120 for subsequent dust collection procedures.

The dust collection system 100 can be mounted or present in or near an environment 105 in which potentially harmful dust is present. For example, the environment 105 can be an environment in or within the vicinity of mobile plant equipment for industrial applications, such as mining and drilling equipment. The work process of the plant equipment generates dust, and/or the equipment operate in an environment in which dust particles are present. Since there is an ever-increasing global demand for ore, oil, gas, and other resources, and there are often hazardous dust particles present in this field, the control of dust particles can enable safer operations in the industry. Mobile plant equipment operates in mine sites, drilling sites, landfill sites, construction sites, chemical processing sites, shipping ports, farming operations, and the like. Reducing the exposure to dust can lessen the occurrences of disorders of individuals exposed to the dust particles, including silicosis, asbestosis, coal worker's pneumoconiosis, and/or other ailments. Operators in and near the dust, such as individuals in the operator cabin of mining and drilling machinery, or the maintenance and service crew personnel, are particularly susceptible to the dust dangers. Accordingly, the use of the dust collection system 100 in these areas is of particular benefit. The use of the dust collection system 100 in environments that also house equipment and electronics can also help to prevent rust-related damage to the equipment.

Additional accessories may be provided to help facilitate the uptake and collection of dust. For example, as shown in FIG. 1C, a hose set 160 can be provided that is selectively connectable to the inlet 135 of the dust containment unit 125. A hose connector 165 can be provided at a first end 170 of the hose set 160. The hose connector 165 is designed to securely, sealingly, and releasably connect the hose set 160 to the inlet 135 of the dust containment unit 125. At a second end 175 of the hose set 160 a hose set opening 180 is provided. A lumen extends from the first end 170 of the hose set 160 to the second end 175 of the hose set 160 so that the hose set opening 180 is in flow communication with the inlet 135. In this way, when the hose set 160 and the inlet 135 are connected, the vacuum from the inlet 135 can be passed to the hose set opening 180. Flexible tubing 185 of the hose set 160 allows the hose set opening 180 to be moved to a location where dust is present so that the dust can be taken up by the hose set 160 under vacuum and delivered to the dust containment unit 125. To use the hose set 160, the plug 140 is removed from the inlet 135 and the hose set 160 is connected to the inlet 135 by the hose connector 165. The dust collection system 100 is powered on, and dust is collected through the hose set 160 and into the dust containment unit 125. Alternatively, the hose set 160 can be preconnected to the inlet 135, as shown in FIG. 1C, and a hose set plug 190 can be secured within the opening 185 to seal the lumen of the hose set 160 and the dust containment unit 125. The hose set plug 190 can be the same as the plug 140 or can be a different sealing member. One or more hose clips 195 can be provided on the dust collection body 110 to conveniently store the hose set 160 when not in use and/or when in use but without the full length of the hose set 160 being needed.

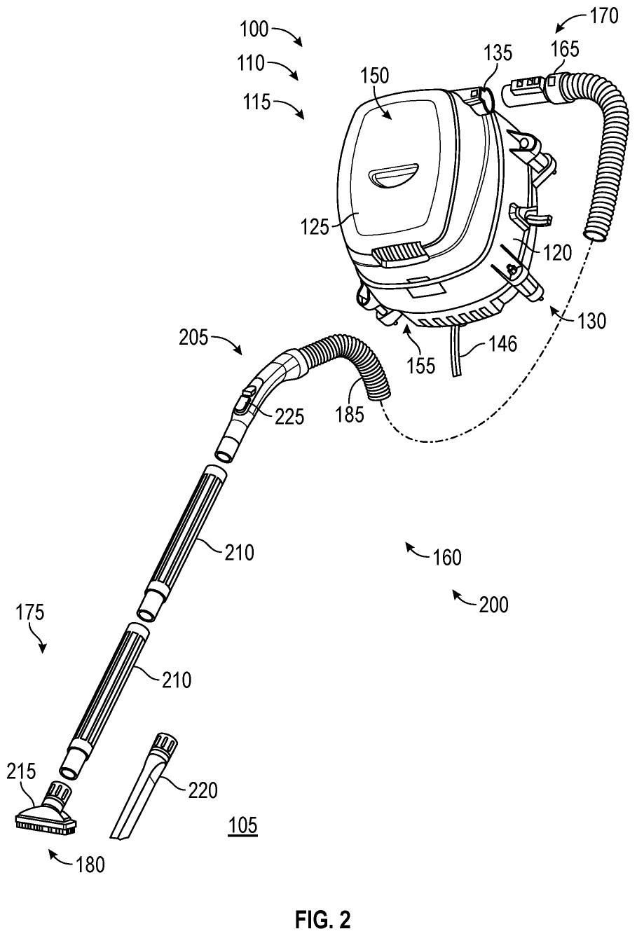

FIG. 2 shows a version of a dust collection system 100 with a multi-piece hose set 200. The multi-piece hose set 200 can include one or more additional pieces. For example, and as shown in FIG. 2, the multi-piece hose set 200 can include one or more of a bend connector 205, an extension pipe 210, an upholstery nozzle 215, and a crevice tool 220. In the version shown, the bend connector 205 also includes an air adjuster 225.

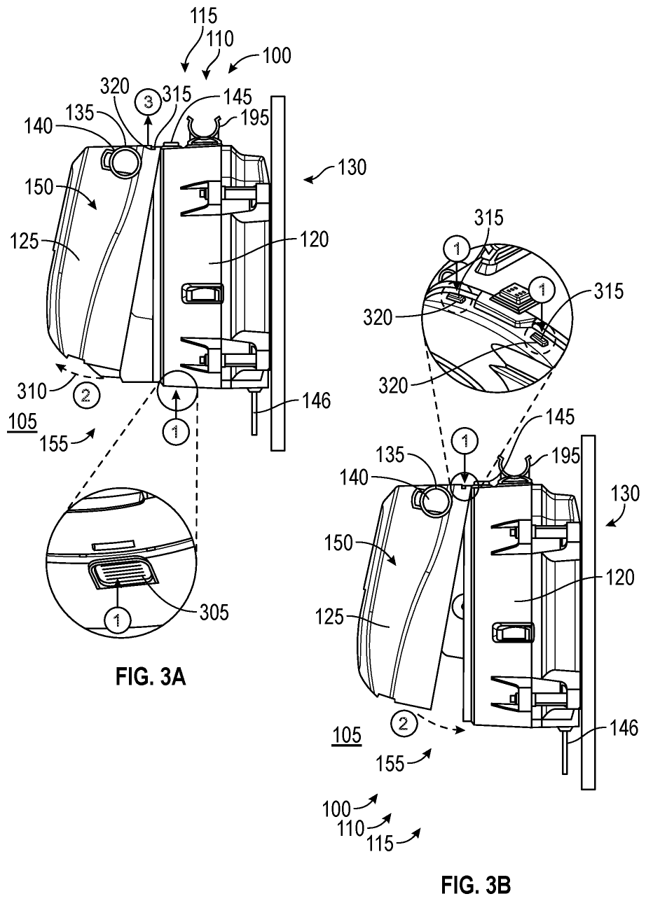

FIGS. 3A and 3B show a version of the releasable connection mechanism 155 of the dust collection system 100 in operation. To release the dust containment unit 125 from the vacuum base 120, as shown in FIG. 3A, first a button 305 is depressed on the bottom of the vacuum base 120. The button 305 when depressed allows the bottom of the dust containment unit 125 to be swung away from the bottom of the vacuum base 120, as shown by arrow 310. After the bottom of the dust containment unit 125 is detached from the vacuum base 120, the dust containment unit 125 can then be lifted off one or more protrusions 315 on the top of the vacuum body 120 that fit within one or more recesses 320 in the dust containment unit 125. As then shown in FIG. 3B, to reconnect the dust containment unit 125 onto the vacuum base 120 or to connect a different dust containment unit 125 onto the vacuum base 120, the reverse operation is performed. The one or more recesses 320 in the dust containment unit 125 are fitted over the one or more protrustions 315 on the vacuum base 120 and then the bottom of the dust containment unit 125 is swung towards the bottom of the vacuum body 120 so that button 305 allows the bottoms to holdingly engage.

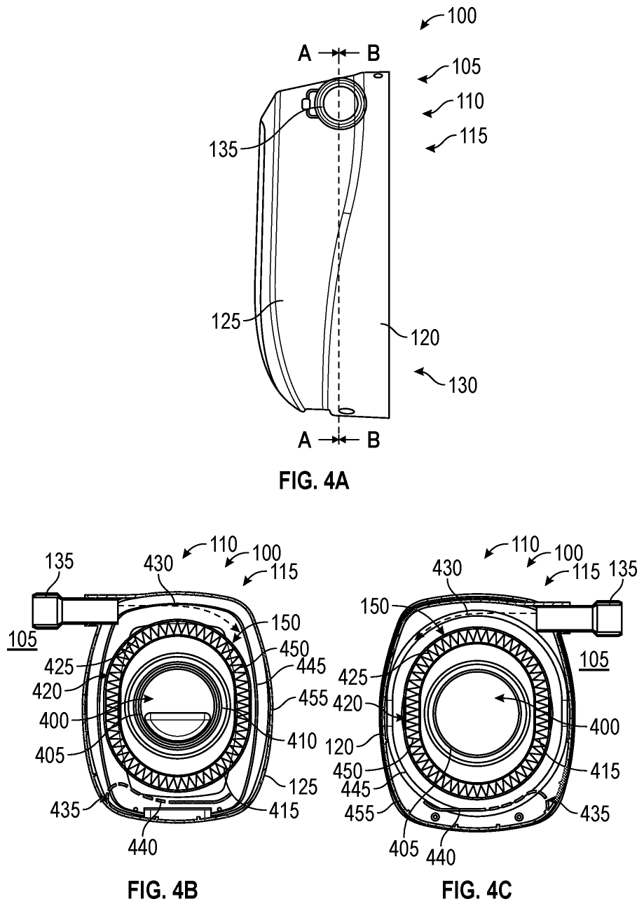

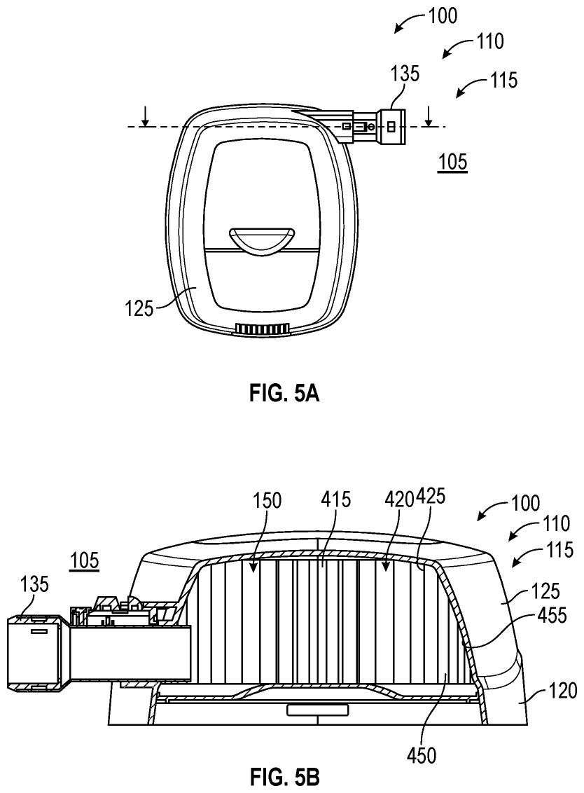

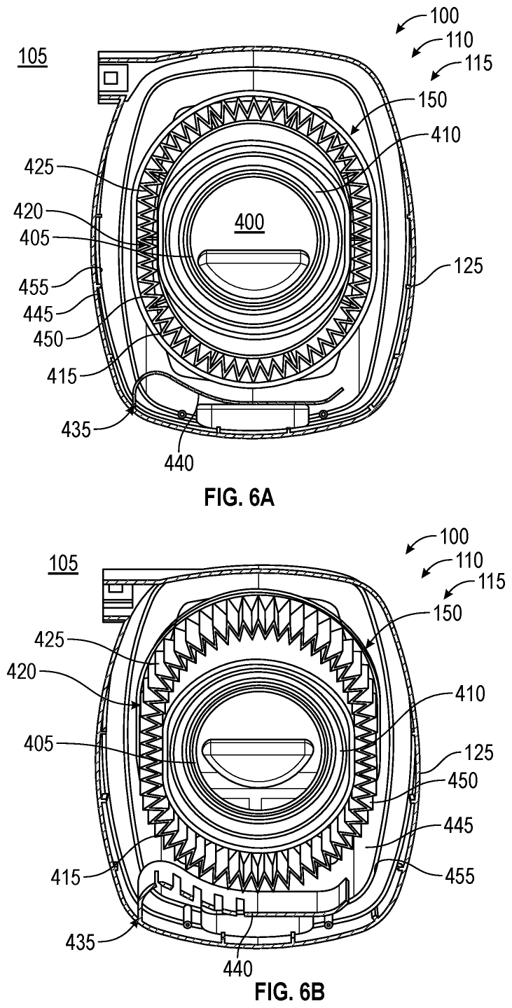

FIGS. 4A, 4B, 4C, 5A, 5B, 6A, and 6B show a version of a dust containment unit 125 for use with the dust collection system 100. FIG. 4A is a side view of the dust containment unit 125, and FIGS. 4B and 4C are sectional view of the dust containment unit 125 in the forward direction along A-A and in the rearward direction along B-B, respectively. A central region 400 of the dust containment unit 125 includes an orifice 405 that is in communication with the vacuum base 120 so that a vacuum can be provided to the dust containment unit 125. A sealing member 410 is in contact with the vacuum base 120 and forms an air intake seal on route to the motor in the vacuum base 120. Between the central region 400 and the inlet 135 is positioned a filter member 415 that makes up the filtering mechanism 150. In the version shown, the filter member 415 has a geometrical shape that is solid and hollow in its two-dimensional cross-section in the direction of A-A and B-B so that the filter member 415 has a circumference that surrounds the central region 400 in this cross-section. The general macro shape of the cross-section of the filter member 415 can be round, circular, oval, ovate, square, rectangular, polygonal, and/or a mix of these shapes. The outer region 420 of the filter member 415 can include one or more ridges 425 or bends that serve to increase the surface area of the filter member 415.

The suction created by the vacuum in the central region 400 pulls air from the inlet 135 towards the central region 400. During this process, particles of dust are captured by the filter member 415 which has openings large enough to allow passage of air but small enough to capture particles of a desired size. In one version, the filter member 415 can be a HEPA filter, or the like. In the version shown, the inlet 135 can be positioned tangentially so as to create a centrifugal airflow 430 as air flows from the inlet to the central region 400 and the orifice 405 on its way to the motor in the vacuum base 120. Large particles in the airflow can be captured by a large particle capture member 435 which in the version shown includes a U-shaped clip 440. Smaller particles are captured by the filter member 415 as the airflow passes through the filter member 415 on its way to the central region 400. The filter member 415 extends generally from the front to the back of the dust containment unit 125 so that the air must pass through the filter member 415 as it travels from the inlet 135 to the central region 400. The dust is thus contained within the dust containment unit 125 in a dust collection region 445 between the outer surface 450 of the filter member 415 and an outer wall 455 of the dust containment unit 125.

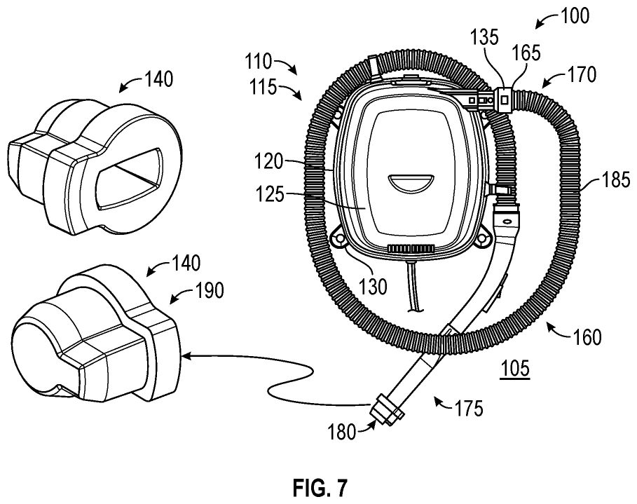

FIG. 7 shows a version of a dust collection system 100 of the invention with one or more plugs 140. The one or more plugs 140 can be used to seal the inlet 135 and/or the hose opening 180, as discussed above. The same plug 140 can be designed to fit either the inlet 135 or the hose opening 180 or different plugs can be provided. The plug 140 can be used to plug the hose opening 180 and/or the inlet 135 in between uses if a single use does not fill the dust containment unit 125. Once the dust containment unit 125 is full, the plug 140 is used to seal the inlet 135 so that the dust containment unit 125 with the filter member 415 and the dust contained therein can be removed from the vacuum base 120 and discarded.

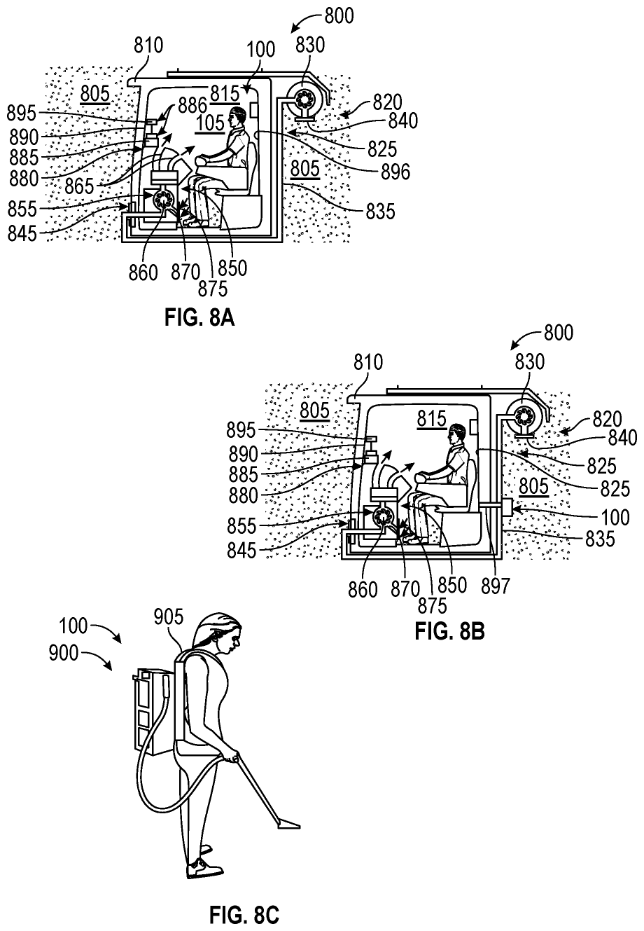

FIG. 8A shows an operator cabin 800 having dust containment system 100 installed within its interior. The dust collection system 100 is particularly useful in association with a cabin 800 associated with heavy equipment, such as mobile plant equipment including for example mining and/or drilling equipment. By cabin it is meant any compartment within or in proximity to the heavy equipment or any compartment within an area that is exposed to dust generated by the heavy equipment or otherwise generated in proximity to the heavy equipment and/or cabin. The cabin can include an operator cabin large enough for a human operator, an operational cabin that is smaller and can be controlled remotely, and a cabinet that houses particular pieces of equipment such as electrical and/or computer equipment. Mobile plant equipment can be used for mining, drilling, or otherwise processing in environments including but not limited to mine sites, drilling sites, landfill sites, construction sites, chemical processing sites, shipping ports, farming operations, and the like. During the process of mining, drilling or otherwise processing these sites, the cabin 800 is operated in an external environment 805 where large amounts of dust are generated. The cabin 800 can include a shell 810 that defines an interior 815. A human operator, operational equipment, and/or electrical equipment within the interior 815 is shielded from the environment 805 by the shell 810. If undesirable amounts of the dust particles are present within the cabin 810, the dust particles can be harmful to the human operator and/or to the equipment and systems within the cabin 810.

In order to help prevent or reduce dust particles from penetrating into the interior 815 of the cabin 810, a positive pressure unit 820 is provided, as shown in FIG. 8A. The positive pressure unit 820 includes an air intake 825 that takes in air from the external environment 805. A positive pressure fan 830, such as a brushless motor fan, causes air from the external environment 805 to be taken in and to pass through a channel 835. In one particular version, the positive pressure fan 830 is a variable speed brushless motor with a centrifugal precleaner. A filter 840 is provided at the air intake 825 to prevent or reduce the amount of dust particles that are taken in by the air intake 825. The filter 840 can be any filter that removes at least a portion or percentage of the dust particles from the air, such as a HEPA filter, a charcoal filter, a nano diesel particulate matter filter, and the like. The channel 835 leads to a cabin inlet 845 where clean, hazard free, pressurized air may be delivered into the interior 815 of the cabin 810. The delivery of air causes a positive pressure to be built up and/or maintained with the interior 815 of the cabin 810 so that the air pressure in the cabin 800 is greater than the air pressure in the external environment 805.

The positive pressure unit 820 creates a sufficient amount of air pressure in the interior 815 of the cabin 800 to prevent dust particles from seeping into the cabin 800. Without the positive pressure, dust particles can migrate from the external environment 805 through gaps or seems in the shell 810 of the cabin 800. The inlet 845 may be a vent that delivers air directly to the interior 815. In the version shown in FIG. 8, the inlet 845 delivers the air directly into an air circulation unit 850. The air circulation unit 850 includes an air flow passageway 855. A circulation fan 860, such as a brushless motor, drives air through the air flow passageway 855 and into the interior 815 through one or more conduits 865 so that the air is blown into the interior 815 of the cabin 800. Optionally, the air circulation unit 850 can include a heating and/or cooling unit to help maintain a desired temperature within the cabin 800. The air flow passageway 855 extends from a return air intake 870 to the one or more conduits 865. The return air intake 870 receives air from the interior 815 by the suction action caused by the circulation fan 860 and/or the positive pressure in the interior 815 caused by the circulation fan 860 and/or the positive pressure fan 830. The return air intake 870 within the interior 815 can have a filter 875 to help prevent the circulation of any dust particles that have made their way into the cabin 800. The filter can be a HEPA filter or the like.

In one version, a control system 880 is provided that monitors and maintains the conditions in the interior 815 of the cabin 800. The control system 880 can comprise a controller 885 that receives one or more signals related to a condition in the cabin 800 and that can generate an output signal in response to that condition. The control system 880 can include one or more detectors 886. For example, in one version, the one or more detectors 886 can include a pressure sensor 890 that senses the air pressure in the interior 815 of the cabin 800. The pressure sensor 890 is in communication with the controller 885 and provides a signal to the controller in relation to the air pressure. The controller is in communication with and can control the operation of the positive pressure fan 830 of the positive pressure unit 820 so that the amount of air being delivered to the cabin 800 can be adjusted in relation to the detected pressure from the pressure sensor 890. When the pressure is detected to be below a desired level, the controller 885 can cause the positive pressure unit 820 to increase the amount of air being delivered to the cabin 800, such as by increasing the speed of the positive pressure fan 830. Similarly, when the pressure is detected to be above a desirable level, the controller 885 can cause the positive pressure unit 820 to decrease the amount of air being delivered to thereby lower the pressure in the cabin 800.

The pressure within the cabin 800 can be maintained at a desirable pressure. In one version, the pressure within the cabin 800 is maintained at between about 20 Pascals and 70 Pascals. In one particular version, the pressure within the cabin 800 is maintained at between about 25 Pascals and about 65 Pascals or between about 25 Pascals and about 35 Pascals. In another particular version, the pressure in the cabin 800 is maintained at a pressure greater than about 30 Pascals or at a pressure between about 30 Pascals and about 60 Pascals. In another particular version, the pressure within the cabin 800 is maintained at a pressure that is at least about 5 Pascals above the pressure of the external environment 805 or that is at least about 10 Pascals above the pressure of the external environment 110. In another version, the pressure within the cabin 800 is maintained at a selectable pressure, such as at about 10 Pascals, at about 20 Pascals, at about 30 Pascals, at about 40 Pascals, at about 50 Pascals, or at about 60 Pascals. Pressure in the cabin 800 will drop if a window or door has been opened, for example. The controller 885 can also log and/or transmit this data, including all pressures, alarms, key indicators, and preset metrics for monitoring and/or analysis. This data can be transmitted independently through communications infrastructure or in constitute with the machine's vehicle management system (VMS). When the pressure in the cabin 105 drops below a predetermined level, a visual and/or audible alarm may be activated.

In one version, the controller 885 is a rugged, industrial controller, designed to monitor, record, transmit, and/or intelligently control the cabin pressure inside the interior 815 of the cabin 800. Efficient cabin pressure management ensures harmful dust particles and toxic fumes cannot ingress into the cabin 800 and be inhaled by an operator and/or damage equipment. In one version, the controller 885 has a built-in 14 bit digital pressure sensor that can accurately measure pressures from about −250.0 Pascals to about +250.0 Pascals with repeatable accuracy. An alarm set point can be set via a user keypad or other input device and can range from about 0.0 Pascals to about 100.0 Pascals. If the pressure falls below the set point, a light, an audible signal and/or other altering device can be activated, either locally or remotely. The alarm can be manually deactivated and/or can remain on until the controller 885 has caused the cabin pressure to return to a safe level.

In another version of the invention, as also shown in FIG. 8A, the cabin 800 may also or alternatively include a different detector 886. For example, in one version, the one or more detectors 886 can comprise a dust sensor 895 as part of the control system 880. The dust sensor 895 can sense the presence of dust and/or particles in the air and/or their concentration and are often referred to as dust particle sensors. The dust sensor 895 is also in communication with the controller 885 and can alert the controller 885 when the amount of dust particles present in the interior 815 of the cabin 800 is above a predetermined level. The dust sensor 895 can be a separate detector or can be incorporated into the controller 885. The dust sensor 895 can be mounted anywhere in the interior 815 of the cabin 800, preferably at a height level that is approximately the same as the head of a human operator if a human operator is present in the cabin 800 and/or the height of equipment that is to be protected.

The dust sensor 895 may be any detector that is capable of measuring the amount and/or concentration of dust and/or particles in the cabin 800. In one version, the dust sensor 895 uses an infrared and/or laser optical sensor. Other dust sensing systems may alternatively or additionally be used. The system used may vary according to operational functionality, type, sensitivity, accuracy, and/or site or operations requirements, including dust or particle properties.

The dust sensor 895 is in communication with the controller 185 and provides a signal to the controller 885 in relation to the air quality, i.e. the quantity and/or quality of dust particles in the cabin 800. The controller 885 is in communication with and can control the operation of the circulation fan 860 and/or the positive pressure fan 830. In one particular version, the controller 885 controls the operation of the circulation fan 860 of the air circulation system 850 so that the amount of air being filtered within the cabin 800 can be adjusted in relation to the detected dust particle level from the dust sensor 895. When the level of dust particles is detected to be above a desired level, the controller 885 can cause the air circulation system 850 to increase the amount of air being exchanged within the cabin 800. In like manner, when the level of dust particles in the cabin 800 is detected to be below a desirable level, the controller 885 can cause the air circulation system 850 to decrease the amount of air being exchanged by decreasing the speed of the circulation fan 860. This decrease in fan speed will also correspondingly reduce the noise in the cabin 800, reducing system decibel levels. This can be a significant factor when considering operator's comfort, concentration, and long-term exposure to noise levels. It also significantly reduces system maintenance requirements while increasing component and filter life. In one version, the desirable level of dust is less than about 10 mg/m3, or less than about 5 mg/m3, or less than about 0.1 mg/m3, as calculated on a time weighted average basis per element and regulated by local, national, or industry standards and as further discussed below.

A dust collection system 100 can be provided within or near the cabin 800 to help collect dust that in the interior 815 of the 800. The collection can be performed periodically and/or when warranted by the detection of a high level of dust by the dust sensor 895. As shown in FIG. 8A, the dust collection system 100 can be mounted on an interior wall 896 of the cabin 800. Alternatively, the dust collection system 100 can be mounted externally and be in communication with the interior 815 through a conduit 897, which can be the hose set or a tube that receives the hose set, or the like.

In another version, as shown in FIG. 8C, the dust collection system 100 can be in the form of a portable unit 900 that can be carried by a user. The portable unit 900 can include one or more straps 905 or the like to assist in the carrying of the unit.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” and their variations such as “consists” should be understood to imply the inclusion of a stated element, limitation, or step and not the exclusion of any other elements, limitations, or steps or any other non-essential elements, limitations, or steps, respectively. Throughout the specification, any discussed on a combination of elements, limitations, or steps should be understood to include a disclosure of additional elements, limitations, or steps and the disclosure of the exclusion of additional elements, limitations, or steps. All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure or prosecution, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

1. (canceled)

2. A dust collection system comprising:
a vacuum base having a mechanism capable of generating a vacuum;
a dust containment unit having an inlet adapted to receive air from a dust-containing environment, a dust flow pathway, and an orifice, wherein the orifice is positioned to be in communication with the vacuum base so that the vacuum generated by the vacuum base can be delivered to the dust containment unit, through the dust flow pathway, and to the inlet to cause suction to be applied to the inlet, and wherein at least a portion of the dust flow pathway creates a centrifugal airflow;
a filtering mechanism in the dust containment unit and positioned in the dust flow pathway to capture dust drawn through the inlet and contain the captured dust in the dust containment unit;
a large particle capture member in the dust containment unit and positioned to capture particles directed centrifugally outward by the dust flow pathway; and
a releasable connection mechanism adapted to releaseably connect the dust containment unit to the vacuum base,
whereby when the dust containment unit contains dust, the dust containment unit can be disconnected from the vacuum base.

3. A dust collection system according to claim 2 wherein the dust containment unit comprises a plug adapted to seal the inlet when dust is contained within the dust containment unit.

4. A dust collection system according to claim 2 wherein the dust containment unit is a first dust containment unit and wherein the dust collect system further comprising a second dust containment unit that can replace the first dust containment unit.

5. A dust collection system according to claim 2 wherein the inlet is positioned tangentially on the dust collection unit to generate the centrifugal flow.

6. A dust collection system according to claim 2 wherein the large particle collector comprises a U-shaped clip.

7. A dust collection system according to claim 2 wherein the large particle collector comprises a U-shaped clip and wherein the centrifugal flow directs large particles into the U-shaped clip.

8. A dust collection system according to claim 2 wherein the filtering mechanism includes a filter member with a circumferential shape that surrounds the orifice.

9. A dust collection system according to claim 2 wherein the filtering mechanism includes a filter member that surrounds the orifice and wherein the filter member has a circumferential shape comprising one or more of a round, circular, oval, ovate, square, rectangle, and polygon.

10. A dust collection system according to claim 2 wherein the filtering mechanism includes a filter member that surrounds the orifice and includes ridges.

11. A dust collection system according to claim 2 wherein the filter mechanism comprises a HEPA filter.

12. A dust collection system according to claim 2 wherein the vacuum base comprises a wall attachment.

13. A dust collection system according to claim 2 further comprising a hose set that is connectable to the inlet.

14. A method of collecting dust, the method comprising:
providing a vacuum base having a mechanism capable of generating a vacuum;
releasably connecting a dust containment unit to the vacuum base, the dust containment unit having an inlet adapted to receive air from a dust-containing environment, a dust flow pathway, and an orifice, wherein the orifice is positioned to be in communication with the vacuum base so that the vacuum generated by the vacuum base can be delivered to the dust containment unit, through the dust flow pathway, and to the inlet to cause suction to be applied to the inlet, and wherein at least a portion of the dust flow pathway creates a centrifugal airflow;
filtering air flowing through the dust flow pathway to capture dust drawn through the inlet and containing the captured dust in the dust containment unit;
capturing large particles in the dust containment unit by positioning a large particle capture member so that particles are directed centrifugally outward by the dust flow pathway towards the large particle capture member; and
disconnecting the dust containment unit from the vacuum base so that the dust can be disposed of.

15. A method according to claim 14 further comprising disposing of the dust containment unit.

16. A method according to claim 14 further comprising sealing the dust containment unit and then disposing of the dust containment unit.
